(19) United States
(12) Patent Application Publication
(10) Pub. No.: US 2024/0416399 A1
(43) Pub. Date: Dec. 19, 2024

(54) CLEANING WATER TANK AND CLEANING DEVICE

(71) Applicant: BEIJING XIAOMI MOBILE SOFTWARE CO., LTD., Beijing (CN)

(72) Inventors: Chunming REN, Beijing (CN); Ning GE, Beijing (CN); Yijun ZHANG, Beijing (CN)

(73) Assignee: BEIJING XIAOMI MOBILE SOFTWARE CO., LTD., Beijing (CN)

(21) Appl. No.: 18/497,532

(22) Filed: Oct. 30, 2023

(30) Foreign Application Priority Data
Jun. 19, 2023 (CN) 202310729577.5

(51) Int. Cl. B08B 9/08

(52) U.S. Cl. CPC B08B 9/0808

(57) ABSTRACT

A cleaning water tank includes a water tank housing and a switch assembly. The water tank housing includes a water storage cavity, a water injection port in a side of the water tank housing, and a water outlet in a bottom of the water tank housing. The water injection port and the water outlet are both communicated with the water storage cavity. The switch assembly is movably arranged to the water tank housing. The water storage cavity is configured to be isolated from an outside air, when the switch assembly is in a closed position, and the water storage cavity is configured to be communicated with the outside air to form a pressure difference, when the switch assembly is in an open position, to allow water in the water storage cavity to be discharged from the water tank housing via the water outlet under the action of the pressure difference.

### CROSS-REFERENCE TO RELATED APPLICATION

This application is based on and claims priority to Chinese Patent Application No. 202310729577.5 filed on Jun. 19, 2023, the entire contents of which are incorporated herein by reference for all purposes.

### BACKGROUND

### Technical Field

Cleaning devices can help people free their hands from heavy cleaning work. Common cleaning appliances include a vacuum cleaner, a sweeper and a floor scrubber. With the development and progress of technology, people's cleaning needs are constantly increasing, and more and more cleaning appliances begin to expand the function of mopping the floor. For example, the early vacuum cleaner only has the function of vacuuming, which cannot meet the use requirements well. At present, the cleaning device such as the vacuum cleaner with the wet mopping function is gradually recognized and popularized by the public.

### Description of the Related Art

Usually, the cleaning device equipped with the water tank has the function of wet mopping, which can meet the cleaning needs of the user. In the related art, the water filling port (the water injection port) of the water tank is often located in the top surface of the water tank, and the flat and long structure of the water tank results in that the water cannot fill up the water tank or the water tends to overflow when filling the water, and that the water cannot be emptied while pouring out the water, which lowers the user's experience of the cleaning device.

### SUMMARY

The present disclosure relates to a field of cleaning, and in particular to a cleaning water tank and a cleaning device.

A first aspect of the present disclosure provides a cleaning water tank, including: a water tank housing including a water storage cavity therein, a water injection port in a side of the water tank housing, and a water outlet in a bottom of the water tank housing, and the water injection port and the water outlet being both communicated with the water storage cavity; and a switch assembly movably arranged to the water tank housing. The water storage cavity is configured to be isolated from an outside air, when the switch assembly is in a closed position, and the water storage cavity is configured to be communicated with the outside air to form a pressure difference, when the switch assembly is in an open position, to allow water in the water storage cavity to be discharged from the water tank housing via the water outlet under the action of the pressure difference.

A second aspect of the present disclosure provides a cleaning device, which includes a cleaning brush and a cleaning water tank. The cleaning water tank includes: a water tank housing including a water storage cavity therein, a water injection port in a side of the water tank housing, and a water outlet in a bottom of the water tank housing, and the water injection port and the water outlet being both communicated with the water storage cavity; and a switch assembly movably arranged to the water tank housing. The water storage cavity is configured to be isolated from an outside air, when the switch assembly is in a closed position, and the water storage cavity is configured to be communicated with the outside air to form a pressure difference, when the switch assembly is in an open position, to allow water in the water storage cavity to be discharged from the water tank housing via the water outlet under the action of the pressure difference. The cleaning brush is detachably connected with the water tank housing of the cleaning water tank.

It is to be understood that both the foregoing general description and the following detailed description are illustrative and explanatory only and are not restrictive of the present disclosure.

### BRIEF DESCRIPTION OF THE DRAWINGS

In order to explain the technical solution in the embodiments of the present disclosure more clearly, the drawings needed in the description of the embodiments will be briefly introduced below. Obviously, the drawings in the following description are only some embodiments of the present disclosure. For ordinary technicians in the field, other drawings can be obtained according to these drawings without inventive effort.

FIG. 1 is a perspective view of a cleaning water tank in an illustrative embodiment of the present disclosure.

FIG. 2 is a perspective view of a cleaning water tank in another illustrative embodiment of the present disclosure.

FIG. 3 is a sectional view of a cleaning water tank in an illustrative embodiment of the present disclosure.

FIG. 4 is an exploded view of a cleaning water tank in an illustrative embodiment of the present disclosure.

FIG. 5 is a partial enlarged view of a cleaning water tank in an illustrative embodiment of the present disclosure.

FIG. 6 is an enlarged view of a part in FIG. 3 corresponding to a plug cover.

FIG. 7 is a perspective view of a switch assembly in an illustrative embodiment of the present disclosure, in which a blocking switch of the switch assembly is in an open position.

FIG. 8 is a sectional view of a switch assembly in an illustrative embodiment of the present disclosure, in which a blocking switch of the switch assembly is in an open position.

FIG. 9 is a perspective view of a switch assembly in an illustrative embodiment of the present disclosure, in which a blocking switch of the switch assembly is in a closed position.

FIG. 10 is a sectional view of a switch assembly in an illustrative embodiment of the present disclosure, in which a blocking switch of the switch assembly is in a closed position.

FIG. 11 is a partially exploded view of a switch assembly in an illustrative embodiment of the present disclosure.

FIG. 12 is a perspective view of a sealing component in an illustrative embodiment of the present disclosure.

FIG. 13 is a perspective view of a sealing component in another illustrative embodiment of the present disclosure.

FIG. 14 is a perspective view of a sealing component in yet another illustrative embodiment of the present disclosure.

FIG. 15 is a partial exploded view of a cleaning device in an illustrative embodiment of the present disclosure.

### DETAILED DESCRIPTION OF THE PREFERRED EMBODIMENTS

Reference will now be made in detail to illustrative embodiments, examples of which are illustrated in the accompanying drawings. When the following description refers to the drawings, unless otherwise indicated, the same numbers in different drawings indicate the same or similar elements. The examples described in the following illustrative embodiments do not represent all embodiments consistent with the present disclosure. Rather, they are merely examples of devices and methods consistent with some aspects of the present disclosure.

The term used in the present disclosure is for the purpose of describing specific embodiments only and is not intended to limit the present disclosure. Unless otherwise defined, technical terms or scientific terms used in the present disclosure shall have their ordinary meanings as understood by those ordinary skilled in the art to which the present disclosure belongs. The terms “first”, “second” and the like used in the present disclosure do not indicate any order, quantity or importance, but are only used to distinguish different components. Similarly, words such as “a”, “an” or the like do not mean quantity limitation, but mean that there is at least one. If only “one” is referred to, it will be explained separately. “A plurality of” or “several” means two or more. Unless otherwise specified, similar words such as “front”, “rear”, “down” and/or “up”, “top” and “bottom” are only for convenience of explanation, and are not limited to a position or a spatial orientation. Similar words such as “include” or “comprise” mean that the elements or objects before “include” or “comprise” cover the elements or objects listed after “include” or “comprise” and their equivalents, but do not exclude other elements or objects. Similar words such as “connect” or “couple” are not limited to physical or mechanical connection, but may include electrical connection, whether direct or indirect.

A cleaning device equipped with a water tank has the function of wet mopping, which can meet the cleaning needs of a user. In the related art, the water tank still has the problem for the user that it is inconvenient to fill water into the water tank and to pour the water out of the water tank and that the water cannot be completely poured out of the water tank. In addition, the water output control solution of the water tank mostly includes a manual switch or an electric control switch for a water outlet. The manual switch needs to be opened or closed manually by the user, which has a risk that the water tank will continue discharging water as the user forgets to close the water tank. The control solution of the electronic control switch is complex and costly, which also has the risk of water leakage. If the accumulated water leaked from the water tank is not cleaned in time, it will easily lead to problems such as damage, moisture increase and mold growth on the floor, which will lower the user's experience of the cleaning device.

The present disclosure proposes a cleaning water tank and a cleaning device to solve at least some problems in the related art. The cleaning water tank and the cleaning device of the present disclosure will be described in detail with reference to the drawings. In case of no conflict, the features in the following embodiments and implementations may be combined with each other.

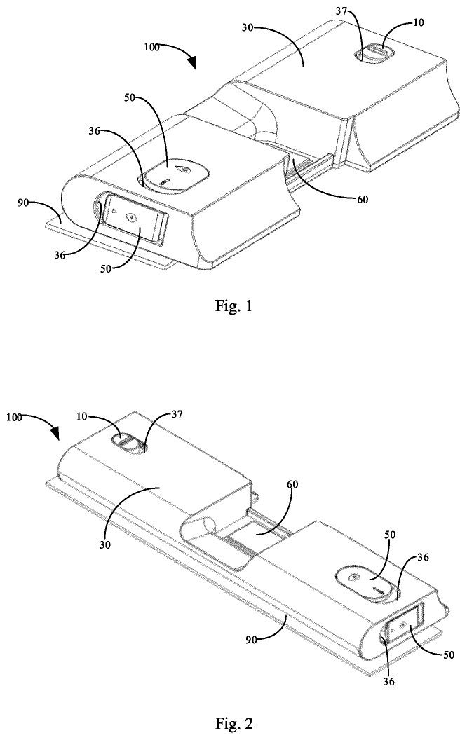

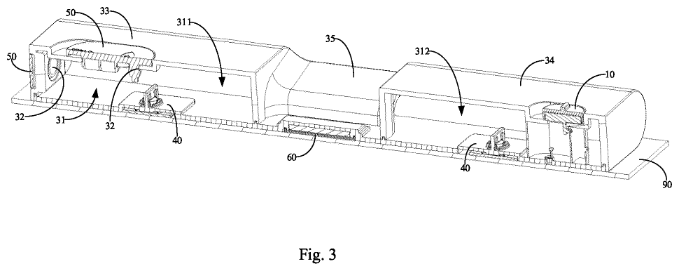

Referring to FIG. 1 to FIG. 4, the present disclosure provides a cleaning water tank 100, which may be an outboard water tank or a built-in water tank, and may be applied to a cleaning device such as a vacuum cleaner, a sweeper, a floor washer, etc., and may also be extended to the field of a moving cleaning device, cleaning tool or cleaning appliance having a water output demand or carrying the cleaning water tank. The cleaning water tank 100 may include a water tank housing 30 and a switch assembly 10.

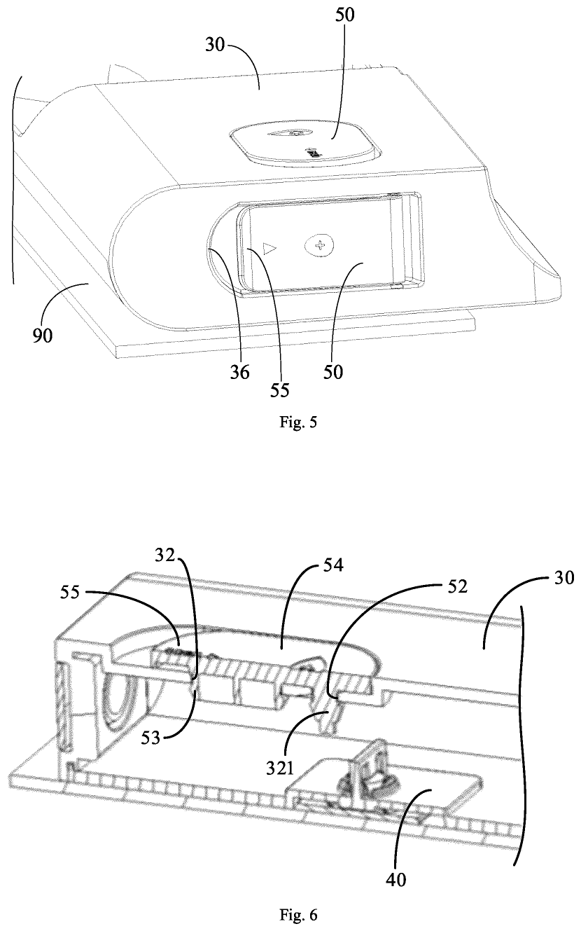

A water storage cavity 31 for storing water is formed in the water tank housing 30, and the water tank housing 30 has a water injection port 32 in a side and a water outlet (not shown) in a bottom. The water injection port 32 and the water outlet are both communicated with the water storage cavity 31. As shown in FIG. 5, it may be understood that the water injection port 32 can realize the function of filling/pouring water, and the number of the water injection ports 32 may be set according to actual needs, which is not limited by the present disclosure. The water outlet is used for discharging the water in the water storage cavity 31.

The switch assembly 10 is movably arranged to the water tank housing 30. When the switch assembly 10 moves to a closed position, the water storage cavity 31 is isolated from the outside air, preventing the water in the water storage cavity 31 from flowing out of the water outlet. When the switch assembly 10 moves to an open position, the water storage cavity 31 is communicated with the outside air to form a pressure difference, and the water in the water storage cavity 31 is discharged from the water tank housing 30 via the water outlet under the action of the pressure difference. In practical applications, auxiliary tools such as a mophead 90 may be assembled to the bottom of the water tank housing 30, and the water flowing out of the water outlet of the water tank housing 30 can wet the auxiliary tools such as the mophead 90 to realize the cleaning function. In some embodiments, the auxiliary tools such as the mophead 90 may be connected with the bottom of the water tank housing 30 through a connecting piece 91 such as an adhesive plate, an adhesive tape and a hook and loop fastener.

Through the above embodiments, it can be seen that the water can be filled into or poured out of the cleaning water tank 100 of the present disclosure by arranging the water injection port 32 in the side of the water tank housing 30, which solves the problem for the user that it is inconvenient to fill the water into the cleaning water tank and to pour the water out of the cleaning water tank and that the water cannot be completely poured out of the cleaning water tank due to only arranging the water injection port in the top of the cleaning water tank in the related art, thus resulting in strong environmental adaptability, providing the user with many choices, addressing the shortage of poor user experience, and improving the user experience. By arranging the switch assembly 10, the problem of the water leakage of the cleaning water tank when the cleaning water tank 100 is forgotten to be closed or when it is static in the related art is solved, thus avoiding the risks of damage, moisture, mold and the like on the floor.

In some embodiments, both the side and the top of the water tank housing 30 may be provided with the water injection port 32, that is, an upper surface and a side surface of the water tank housing 30 may be provided with the water injection port 32, respectively. Compared with the related art, in which the water injection port is only provided in the top of the cleaning water tank, this embodiment can retain the original top water injection port while adding the side water injection port. In this way, the water injection port in the top (i.e. the top water injection port) facilitates filling water, and the water injection port in the side (i.e. the side water injection port) facilitates pouring water.

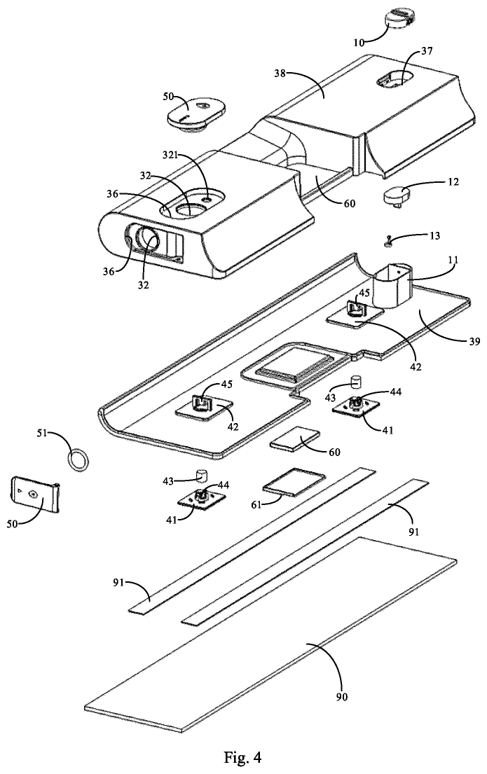

Referring to FIGS. 3 and 4, in some embodiments, the cleaning water tank 100 may further include a water output assembly 40 arranged at the water outlet, and the water output assembly 40 includes a filter element 43. The water in the water storage cavity 31 can be uniformly discharged from the water outlet through the filter element 43 of the water output assembly 40.

Further, the water output assembly 40 may further include a first bracket part 41 and a second bracket part 42. The first bracket part 41 is hermetically connected with the water tank housing 30 from the outside of the water tank housing 30 at a position corresponding to the water outlet, and the second bracket part 42 is hermetically connected with the water tank housing 30 from the inside of the water storage cavity 31 at a position corresponding to the water outlet. Both the first bracket part 41 and the second bracket part 42 have a hole corresponding to the water outlet. One of the first bracket part 41 and the second bracket part 42 includes a mounting portion 44, which penetrates through the water outlet, and the filter element 43 is mounted to the mounting portion 44, so that the filter element 43 is fixed at the water outlet, and thus the water in the water storage cavity 31 can be uniformly discharged from the water outlet through the filter element 43 of the water output assembly 40. In some embodiments, the material of the filter element 43 may be cotton, or other materials facilitating the uniform drainage of the water. Both the first bracket part 41 and the second bracket part 42 may be connected with the water tank housing 30 by ultrasonic sealing.

It may be understood that the first bracket part 41 and the second bracket part 42 are hermetically connected with the water tank housing from the inside and outside of the water tank housing 30 at the position corresponding to the water outlet, and both of them have the hole corresponding to the water outlet, so that when the pressure difference is formed between the inside of the water storage cavity 31 of the water tank housing 30 and the outside air, the water in the water storage cavity 31 can be uniformly discharged from the water outlet through the filter element 43 of the water output assembly 40, which is conducive to uniformly wetting the auxiliary tools such as the mophead 90, so as to achieve great cleaning effects.

Further, the other one of the first bracket part 41 and the second bracket part 42, which is not provided with the mounting portion 44, may include a limiting portion 45, and the limiting portion 45 is fitted with the mounting portion 44 to limit the mounting portion 44, so that the filter element 43 is stably fixed at the water outlet. In this embodiment, the first bracket part 41 includes the mounting portion 44, and the second bracket part 42 includes the limiting portion 45.

Referring to FIG. 3, in some embodiments, the water tank housing 30 may include a first housing part 33, a second housing part 34 and an intermediate housing part 35, which are arranged side by side, and the first housing part 33 and the second housing part 34 are connected to two ends of the intermediate housing part 35, respectively. A first water storage cavity 311 is formed in the first housing part 33, a second water storage cavity 312 is formed in the second housing part 34, and an intermediate water storage cavity (not shown) is formed in the intermediate housing part 35. The first water storage cavity 311, the second water storage cavity 312 and the intermediate water storage cavity are communicated to form the water storage cavity 31.

It may be understood that the water storage cavity 31 may include the first water storage cavity 311 and the second water storage cavity 312 communicated with each other. Further, the bottom of the water tank housing 30 has water outlets corresponding to the first water storage cavity 311 and the first water storage cavity 311 respectively. Two water output assemblies 40 are provided, and they are arranged at the water outlet corresponding to the first water storage cavity 311 and the water outlet corresponding to the second water storage cavity 312, respectively. In this way, the water tank housing 30 may be elongated, and the water storage cavity 31 is also elongated accordingly, which is divided into two parts, namely, the first water storage cavity 311 and the second water storage cavity 312. The water tank housing 30 includes the water outlets and the water output assemblies 40 corresponding to the first water storage cavity 311 and the second water storage cavity 312, which can achieve the effect of uniformly discharging water from two sides of the cleaning water tank.

In some embodiments, one of the first housing part 33 and the second housing part 34 includes the water injection port 32, and the other one of the first housing part 33 and the second housing part 34 includes the switch assembly 10. In this embodiment, both the side and the top of the first housing part 33 include the water injection port 32, and the second housing part 34 includes the switch assembly 10. In this way, the functional components are separately arranged on the first housing part 33 and the second housing part 34, so that the housing space of the water tank housing 30 can be utilized reasonably and fully.

Referring to FIG. 4, in some embodiments, the water tank housing 30 may include a water tank upper shell 38 and a water tank lower shell 39 hermetically connected with the water tank upper shell 38. The water tank upper shell 38 and the water tank lower shell 39 enclose the water storage cavity 31, both the side and the top of the water tank upper shell 38 include the water injection port 32, and the water tank lower shell 39 includes the water outlet. It may be understood that the water tank housing 30 is formed by joining the water tank upper shell 38 and the water tank lower shell 39 together. The auxiliary tools such as the mophead 90 may be arranged to the bottom of the water tank lower shell 39. The water output assembly 40 may be arranged to the water tank lower shell 39. In some embodiments, the water tank upper shell 38 and the water tank lower housing 39 may be connected by ultrasonic sealing.

In some embodiments, the cleaning water tank 100 may further include a plug cover 50 movably arranged at the water injection port 32. In this way, when there is no need to fill/pour water, the plug cover 50 may seal the water injection port 32 to prevent the water in the water tank housing 30 from leaking out. When there is need to fill/pour water, the plug cover 50 may be temporarily removed from the water injection port 32 to expose the water injection port 32. In some embodiments, the plug cover 50 is a soft rubber plug, and the soft rubber plug is hermetically connected with the water tank housing 30, so that the soft rubber plug can achieve a great sealing effect. In order to achieve a better sealing effect, a sealing ring 51 may be further provided between the plug cover 50 and the water tank housing 30. It should be noted that the sealing form between the plug cover and the water tank housing may be realized by the way of the soft rubber and the hard housing being fitted and sealed or the way of the sealing ring and the hard housing being fitted and sealed.

Further, the upper surface and the side surface of the water tank housing 30 may include a first groove 36 respectively, the water injection port 32 is formed in a bottom wall of the first groove 36, and the plug cover 50 may be movably arranged in the first groove 36 and correspond to the water injection port 32. In this way, the plug cover 50 does not protrude from the surface of the water tank housing 30, and the appearance of the product is improved. It may be understood that the water tank housing 30 may also include a second groove 37, and the switch assembly 10 may be movably arranged in the second groove 37, so that the user can move the switch assembly 10 in the second groove 37.

Referring to FIG. 6, in some embodiments, the side and the top of the water tank housing 30 may also include a mounting hole 321 adjacent to the water injection port 32. The plug cover 50 includes a fixing head 52, a sealing head 53 and an intermediate connecting part 54, and the fixing head 52 and the sealing head 53 are connected to two ends of the intermediate connecting part 54, respectively. The fixing head 52 is fixed in the mounting hole 321, and the sealing head 53 is movably plugged in the water injection port 32 for opening and closing the water injection port 32. In this way, when there is no need to fill/pour water, the sealing head 53 can seal the water injection port 32 to prevent the water in the water tank housing 30 from leaking out. When there is need to fill/pour water, the sealing head 53 can be temporarily pulled out of and moved away from the water injection port 32 in a flipped way to expose the water injection port 32, so that the water can be injected or poured. Similarly, when it is to be closed, the sealing head 53 may be pressed back in an opposite direction. In some embodiments, an end of the plug cover 50 close to the sealing head may also be provided with a handle 55, so that it is convenient for the user to flip the sealing head 53.

In some embodiments, the cleaning water tank 100 may further include a connecting part 60 to be connected to an external structure, and the connecting part 60 is arranged to the water tank housing 30. In some embodiments, the connecting part 60 may include at least one of a built-in magnetic attraction member (such as a magnet), an external fastener, and an adhesive member. Further, the cleaning water tank 100 may further include a mounting member 61 for fixing the connecting part 60 to improve the stability of the connecting part 60. The mounting member 61 may be connected with the water tank lower shell 39 by ultrasonic waves to prevent the connecting part 60 from falling off.

In some embodiments, the water tank housing 30 may include a first vent 1111, which is communicated with the inside of the water storage cavity 31 and the outside of the water storage cavity 31. When the switch assembly 10 is in the closed position, the switch assembly 10 blocks the first vent 1111 to isolate the water storage cavity 31 from the outside air. When the switch assembly 10 is in the open position, the switch assembly 10 exposes the first vent 1111, so that the water storage cavity 31 is communicated with the outside air to generate the pressure difference. In this way, the water output control of the cleaning water tank is realized.

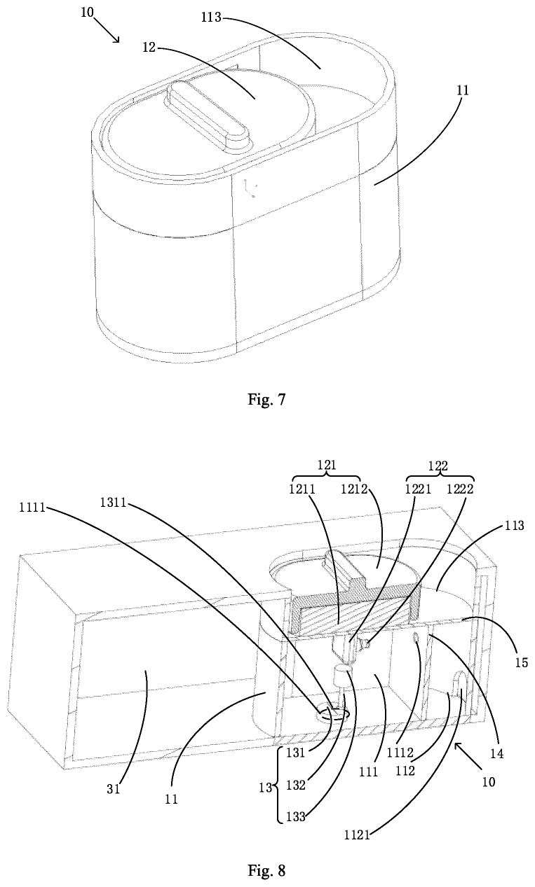

Referring to FIGS. 7 to 10, in some embodiments, the switch assembly 10 includes a case 11, a blocking switch 12 and a sealing component 13. The case 11 is arranged inside the water storage cavity 31 of the water tank housing 30. The case 11 has a first chamber 111, and a wall surrounding the first chamber 111 has a first vent 1111 and a second vent 1112. The first vent 1111 is communicated with the outside of the water storage cavity 31, and the second vent 1112 is communicated with the inside of the water storage cavity 31. The blocking switch 12 is movably assembled to the case 11. The blocking switch 12 includes a blocking part 122 (which may be understood as an ejector pin structure) arranged in the first chamber 111. The blocking part 122 blocks or moves away from the second vent 1112 along with the movement of the blocking switch 12. The sealing component 13 includes a soft sealing member 131, a counterweight member 133, and a deformable connecting member 132 connecting the soft sealing member 131 and the counterweight member 133. The soft sealing member 131 blocks the first vent 1111, and the soft sealing member 131 has a slit 1311. The slit 1311 is in a closed state when the counterweight member 133 is static, and the slit 1311 is in an open state when the counterweight member 133 moves.

The case 11 of the switch assembly 10 has the first chamber 111, the wall surrounding the first chamber 111 has the first vent 1111 and the second vent 1112, the second vent 1112 can be opened or closed by controlling the blocking switch 12 and the first vent 1111 can be opened or closed along with the movement or rest of the counterweight member 133. The water can be discharged out of the water storage cavity 31 from the water outlet in case that air passages inside and outside the water storage cavity 31 are communicated, and the air passages inside and outside the water storage cavity 31 can be unblocked or blocked under the dual control of the blocking switch 12 and the sealing component 13. The sealing component 13 will only open the slit 1311 due to the inertia of the counterweight member 133 during the movement, thus avoiding the water leakage of the water storage cavity 31 caused by forgetting to close the blocking switch 12 or the switch of the water outlet of the water storage cavity or by blocking failure. According to the present disclosure, the sealing effect of the water storage cavity 31 in an undrained state is ensured through a simple structural arrangement, and the user experience of the water storage cavity 31 and the cleaning device using the water storage cavity 31 is improved.

In some embodiments, the case 11 further includes a second chamber 112 communicated with the inside of the water storage cavity 31, and the first chamber 111 and the second chamber 112 are communicated through the second vent 1112. The second chamber 112 may serve as a buffer space between the water storage space of the water storage cavity 31 and the first chamber 111, thus avoiding the problem that the water flows into the first chamber 111 when the air passages inside and outside the water storage cavity 31 are communicated, and improving the usage reliability of the switch assembly 10.

In the above embodiment, a wall surrounding the second chamber 112 may include a second side wall, and the second side wall has a third vent 1121 communicated with the inside of the water storage cavity 31. The communication between the second chamber 112 and the water storage cavity 31 is realized through the third vent 1121, so that the structure of the second side wall may form a partition from the water storage space of the water storage cavity 31, thus reducing the possibility that the water in the water storage cavity 31 flows into the second chamber 112.

In some embodiments, the switch assembly 10 may be assembled in the water storage cavity 31 and to a bottom plate of the cleaning water tank, i.e. the water tank lower shell 39 described above. The wall surrounding the first chamber 111 includes a first bottom wall fitted in the bottom plate of the cleaning water tank and a first side wall connected with the bottom wall. The first vent 1111 is formed in the first bottom wall, and the second vent 1112 is formed in the first side wall. The first vent 1111 is formed in the first bottom wall, so as to be fitted and communicated with a fourth vent at the bottom of the water storage cavity 31. The fourth vent at the bottom of the water storage cavity 31 avoids the problem that the air input passage is covered and blocked by free-falling dust or particles when the water storage cavity 31 is in normal use or laid flat in idle. The second vent 1112 is formed in the first side wall, so that the blocking part 122 can block or move away from the second vent 1112 during the transverse movement, which is helpful to optimize the movement track and structural arrangement of the blocking part 122.

For example, a first partition structure 14 arranged in a longitudinal direction and a second partition structure 15 arranged in a transverse direction may be arranged inside the case 11. An outer wall (i.e. a side wall) of the case 11, a bottom plate of the case 11, the first partition structure 14 and the second partition structure 15 enclose the first chamber 111. The bottom plate of the case 11, the outer wall of the case 11, the first partition structure 14 and the second partition structure 15 enclose the second chamber 112. That is, the first chamber 111 and the second chamber 112 are located on opposite sides of the first partition structure 14, separated by the first partition structure 14 and are both enclosed by the outer wall of the case 11 (for example, at periphery), the bottom plate of the case 11 (for example, at bottom) and the second partition structure 15 (for example, at top). The bottom plate of the case 11 may serve as the first bottom wall having the first vent 1111, and the first partition structure 14 may serve as a part of the first side wall having the second vent 1112.

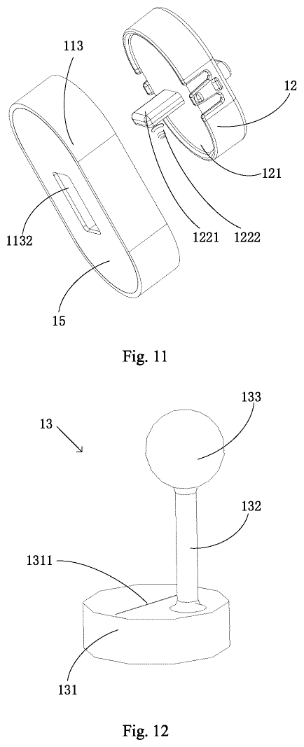

In some embodiments, as shown in FIG. 11, the case 11 may further include a sliding groove 113, and the blocking switch 12 includes an operating part 121 arranged outside the first chamber 111. A bottom of the sliding groove 113 has an assembling opening 1132 communicated with the first chamber 111, and the operating part 121 is movably assembled in the sliding groove 113, and penetrates through the assembling opening 1132 to be connected with the blocking part 122. By manually controlling the operating part 121 to slide along the sliding groove 113, the blocking part 122 can be driven to move, so that the blocking part 122 can block or move away from the second vent 1112.

In the above embodiment, the operating part 121 covers the assembling opening 1132 at any position. That is, the operating part 121 can still cover and block the assembling opening 1132 during the movement, so as to avoid the problem of the water leakage of the water storage cavity 31 due to the air leakage at the assembling opening 1132.

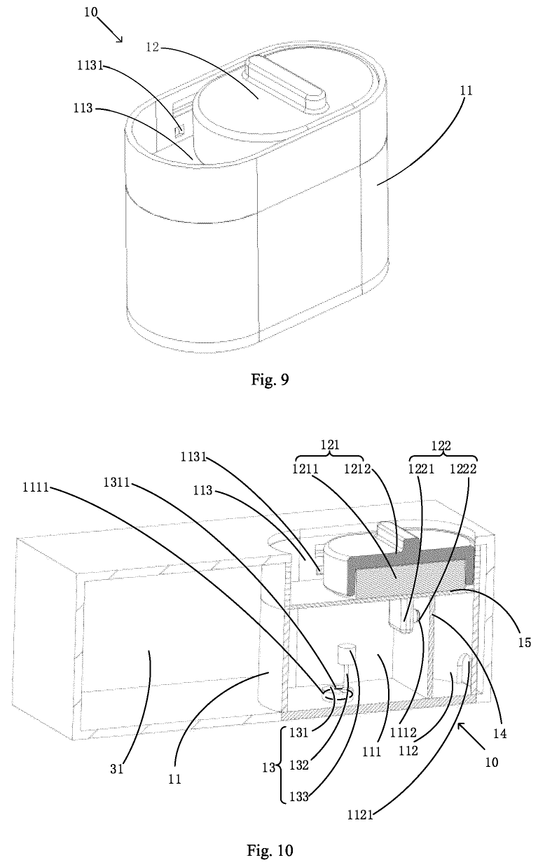

In some embodiments, as shown in FIG. 9 and FIG. 10, a wall of the sliding groove 113 may include a limiting structure 1131, and the limiting structure 1131 includes a transverse limiting part. In a sliding direction of the operating part 121, the operating part 121 is fitted with the transverse limiting part so as to be limited at least in an extreme position, so as to limit the operating part 121 in the open position and the closed position. The transverse limiting part may include two longitudinal limiting ribs arranged at intervals in the transverse direction on the wall of the sliding groove 113, and when the operating part 121 abuts against the longitudinal limiting ribs, it can be limited in the open position or the closed position.

In the above embodiment, the limiting structure 1131 may further include a longitudinal limiting part, and the operating part 121 is engaged with the longitudinal limiting part to be limited in a depth direction (i.e. in the longitudinal direction) of the sliding groove 113. The longitudinal limiting part may be a transverse limiting rib arranged on the wall of the sliding groove 113, and when the operating part 121 is fitted with the transverse limiting rib, it can be limited in the depth direction of the sliding groove 113.

For example, the transverse limiting part and the longitudinal limiting part may be configured as two limiting grooves arranged in the wall of the sliding groove 113. When the operating part 121 is engaged with the limiting groove on one side, it is in the open position, and the blocking part 122 is separated from the second vent 1112. When the operating part 121 is engaged with the limiting groove on the other side, it is in the closed position, the blocking part 122 blocks the second vent 1112. When the operating part is engaged with the above limiting grooves, the operating part 121 can also be prevented from moving in the longitudinal direction, and thus the usage reliability of the operating part 121 can be improved.

In the above embodiment, the wall surrounding the first chamber 111 includes a top wall, which forms the bottom of the sliding groove 113, and one of the operating part 121 and the bottom of the sliding groove 113 includes an elastic material. The elastic material can improve the tightness of fit between the operating part 121 and the bottom of the sliding groove 113, and avoid the air leakage at the assembling opening 1132. The elastic material may be a hard or soft silica gel. For example, the operating part 121 may be made of ABS plastic and the bottom of the sliding groove 113 may be made of silica gel.

In the above embodiment, the operating part 121 may include a slider 1211 and a decorative member 1212 covered on the slider 1211, and the slider 1211 is slidably fitted with the sliding groove 113, so that the user can hold the decorative member 1212 with hands to exert a force so as to push the operating part 121 to slide.

In some embodiments, the switch assembly 10 may include an electronic control module, and the blocking switch 12 is connected with a driving end of the electronic control module to be controlled to drive the blocking part 122 to block or move away from the second vent 1112. When the blocking switch 12 is driven by the electronic control module, the automatic control of the opening and closing of the second vent 1112 can be achieved, thus improving the control intelligence.

In some embodiments, the blocking part 122 may include a connecting structure 1221 and an elastic sealing structure 1222 arranged at an end of the connecting structure 1221. The blocking part 122 may be connected with the driving end of the electronic control module or the manually controlled operating part 121 through the connecting structure 1221, and the elastic sealing structure 1222 may be an elastic structure made of rubber, silica gel or the like and arranged at the end of the connecting structure 1221.

In the above embodiment, the shape of the second vent 1112 includes one of a circle, a cone and a square, and the shape of the elastic sealing structure 1222 matches with the shape of the second vent 1112, which is not limited by the present disclosure.

In some embodiments, the soft sealing member 131, the deformable connecting member 132 and the counterweight member 133 are configured as an integral structure to improve the structural reliability and processing convenience of the sealing component 13. The materials of the soft sealing member 131, the deformable connecting member 132 and the counterweight member 133 may be rubber, silica gel or the like, which is not limited by the present disclosure.

The deformable connecting member 132 may be rod-shaped to support the counterweight member 133. When the switch assembly 10 moves along with the device, the weight member 133 will deform the deformable connecting member 132 due to gravity, so as to pull the soft sealing member 131 to open the slit 1311. When the device is static, the deformable connecting member 132 supports the counterweight member 133 without pulling the soft sealing member 131, so that the slit 1311 is in the closed state.

In the above embodiment, the slit 1311 divides the soft sealing member 131 into a first part and a second part, and the deformable connecting member 132 is arranged to the first part or the second part. Arranging the deformable connecting member 132 to the first part or the second part facilitates pulling one side of the slit 1311 and opening the slit 1311. The slit 1311 may be arranged in the middle of the soft sealing member 131 to make the first part and the second part symmetrical. Alternatively, the slit 1311 may also be arranged at another position of the soft sealing member 131, so that the first part and the second part have different dimensions.

In some embodiments, the slit 1311 includes a linear structure and/or a curved structure.

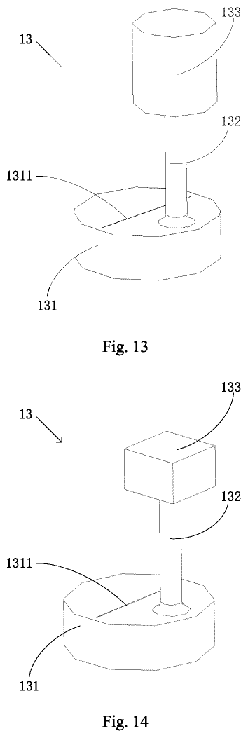

In some embodiments, as shown in FIGS. 12-14, the counterweight member 133 may be one of a cuboid, a sphere, a cylinder and a polyhedron.

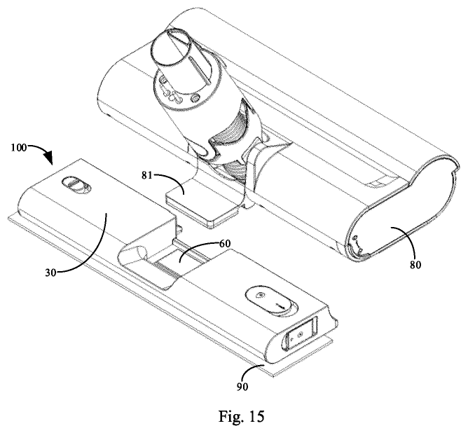

Referring to FIG. 15, the embodiments of the present disclosure also provide a cleaning device, including a cleaning brush 80 and the cleaning water tank 100 described in the above examples and embodiments. The cleaning brush 80 is detachably connected with the water tank housing 30 of the cleaning water tank 100. In some embodiments, the cleaning brush 80 includes a connector 81, which is fitted and connected with the connecting part 60 of the cleaning water tank 100 to realize the assembling of the cleaning brush 80 and the cleaning water tank 100. In some embodiments, the cleaning device may be a sweeping robot, a window cleaning robot, a hand-held sweeper, etc., which is not limited by the present disclosure.

As the switch assembly 10 is assembled as a module, it is convenient for the switch assembly 10 to be mounted to the water storage cavities 31 of different cleaning devices. The case 11 of the switch assembly 10 has the first chamber 111, and the wall surrounding the first chamber 111 has the first vent 1111 and the second vent 1112. The second vent 1112 can be opened or closed by controlling the blocking switch 12, and the first vent 1111 can be opened or closed along with the movement or rest of the counterweight member 133. The water can be discharged out of the water storage cavity 31 from the water outlet in case that air passages inside and outside the water storage cavity 31 are communicated, and the air passages inside and outside the water storage cavity 31 can be unblocked or blocked under the dual control of the blocking switch 12 and the sealing component 13. The sealing component 13 will only open the slit 1311 due to the inertia of the counterweight member 133 during the movement, thus avoiding the water leakage of the water storage cavity 31 caused by forgetting to close the blocking switch 12 or the switch of the water outlet of the water storage cavity or by blocking failure. According to the present disclosure, the sealing effect of the water storage cavity 31 in an undrained state is ensured through a simple structural arrangement, and the user experience of the water storage cavity 31 and the cleaning device using the water storage cavity 31 is improved.

Taking an example in which the cleaning water tank of the present disclosure serves as an outboard cleaning water tank and is applied to a vacuum cleaner, when the user uses the outboard cleaning water tank of the present disclosure on the vacuum cleaner, he/she may choose to add water into the water tank housing by opening the plug cover of the water injection port in the side, or choose to open the plug cover of the water injection port in the top to add water into the water tank housing, which may be flexibly selected according to the actual situation of the household wash basin and faucet and the like, thus improving the user experience. After the water is added, the water injection port may be closed and sealed by the plug cover. After the water is added, the outboard cleaning water tank is placed on the ground upright, and is connected to the vacuum cleaner in a way that the magnet built in the water tank housing is magnetically connected with the connector (for example, a built-in iron sheet) at a rear end of the cleaning brush of the vacuum cleaner, or in a way that the connector at the rear end of the cleaning brush is inserted into a corresponding portion of the water tank housing to realize physical connection through a fastener, an adhesive member and the like.

In practical applications, the user can toggle the operating part of the switch assembly arranged on the water tank housing to the open position to drive the slider and the blocking part (i.e. the ejector pin structure) to move away, so that the first chamber and the second chamber, i.e. the left chamber and the right chamber, are communicated. When the user pushes and pulls the cleaning device to move in various directions, the counterweight member swings under the inertia, and the swinging force is transmitted to the soft sealing member through the deformable connecting member. The slit in the soft sealing member functions as a duckbill valve. When the slit is opened under the action of an external force (i.e. the swinging force), the outside air enters the first chamber from an air hole in the bottom (i.e. the first vent 1111 in the first bottom wall), then enters the second chamber through the second vent, and finally enters the water storage cavity, so that the pressure difference between the inside and the outside of the water storage cavity is realized, and the water is discharged from the water outlet at the bottom of the cleaning water tank under the action of the pressure difference, thus wetting the mophead arranged at the bottom of the cleaning water tank.

After the user uses the vacuum cleaner, the operating part of the switch assembly is toggled to the closed position, and at this time, the blocking part completely blocks the second vent, so that the first chamber and the second chamber are not communicated, and the outside air is prevented from entering the water storage cavity. Thus, the air pressure outside the water storage cavity is greater than the air pressure inside the water storage cavity, and the water in the water storage cavity cannot leak from the water outlet. Even if the user forgets to close the switch assembly and take down the outboard water tank after using it, the counterweight member and the deformable connecting member will return to an original vertical static state without the action of inertia, and the soft sealing member made of soft materials will return to a completely sealed state, which prevents the entry of the outside air, so that the water in the water storage cavity can also be prevented from leaking.

In order to prevent the cleaning water tank from stinking, it is often necessary for the user to clean the mophead and empty the remaining clean water in the cleaning water tank after using the cleaning water tank. Before using the cleaning water tank next time, the user needs to refill the water. Therefore, the user may also choose to empty the remaining clean water from the water injection port in the side or the water injection port in the top after taking the cleaning water tank down. According to experiences and characteristics that the cleaning water tank is generally flat and long, it is difficult to pour out the water and even unable to empty the water when the water is to be poured out from the top of the cleaning water tank, while this problem can be well solved by pouring out the water from the narrow side of the cleaning water tank.

The above description relates to only the preferred embodiments of the present disclosure, and is not intended to limit the present disclosure. Any modification, equivalent substitution, improvement and the like made within the spirit and principle of the present disclosure should be included in the protection scope of the present disclosure.

1. A cleaning water tank, comprising:
a water tank housing comprising a water storage cavity therein, a water injection port in a side of the water tank housing, and a water outlet in a bottom of the water tank housing, and the water injection port and the water outlet being both communicated with the water storage cavity; and
a switch assembly movably arranged to the water tank housing, wherein the water storage cavity is configured to be isolated from an outside air, in case that the switch assembly is in a closed position, and the water storage cavity is configured to be communicated with the outside air to form a pressure difference, in case that the switch assembly is in an open position, to allow water in the water storage cavity to be discharged from the water tank housing via the water outlet under the action of the pressure difference.

2. The cleaning water tank according to claim 1, further comprising a water output assembly arranged at the water outlet, wherein the water output assembly comprises a filter element.

3. The cleaning water tank according to claim 2, wherein the water output assembly further comprises a first bracket part and a second bracket part, the first bracket part is hermetically connected with the water tank housing from outside of the water tank housing at a position corresponding to the water outlet, the second bracket part is hermetically connected with the water tank housing from inside of the water storage cavity at a position corresponding to the water outlet, and the first bracket part and the second bracket part both comprise a hole corresponding to the water outlet; and
one of the first bracket part and the second bracket part comprises a mounting portion, the mounting portion penetrates through the water outlet, and the filter element is mounted to the mounting portion.

4. The cleaning water tank according to claim 3, wherein the other one of the first bracket part and the second bracket part comprises a limiting portion, and the limiting portion is fitted with the mounting portion to limit the mounting portion.

5. The cleaning water tank according to claim 2, wherein the water storage cavity comprises a first water storage cavity and a second water storage cavity communicated with each other, and the bottom of the water tank housing comprises the water outlets corresponding to the first water storage cavity and the first water storage cavity respectively; and
two water output assemblies are provided and arranged at the water outlet corresponding to the first water storage cavity and the water outlet corresponding to the second water storage cavity, respectively.

6. The cleaning water tank according to claim 1, further comprising a plug cover movably arranged at the water injection port.

7. The cleaning water tank according to claim 6, wherein the plug cover is a soft rubber plug, and the soft rubber plug is hermetically connected with the water tank housing.

8. The cleaning water tank according to claim 6, wherein the side of the water tank housing further comprises a mounting hole adjacent to the water injection port, the plug cover comprises a fixed head, a sealing head and an intermediate connecting part, the fixed head and the sealing head are connected to two ends of the intermediate connecting part, respectively, the fixed head is fixed in the mounting hole, and the sealing head is movably plugged in the water injection port.

9. The cleaning water tank according to claim 6, wherein a sealing ring is arranged between the plug cover and the water tank housing.

10. The cleaning water tank according to claim 1, further comprising a connecting part configured to be connected to an external structure, wherein the connecting part is arranged to the water tank housing.

11. The cleaning water tank according to claim 10, wherein the connecting part comprises at least one of a magnetic attraction member, a fastener and an adhesive member.

12. The cleaning water tank according to claim 1, wherein the water tank housing comprises a water tank upper shell and a water tank lower shell hermetically connected with the water tank upper shell, the water tank upper shell and the water tank lower shell enclose the water storage cavity, a side of the water tank upper shell comprises the water injection port, and the water tank lower shell comprises the water outlet.

13. The cleaning water tank according to claim 1, wherein the water tank housing comprises a first housing part, a second housing part and an intermediate housing part arranged side by side, the first housing part and the second housing part are connected to two ends of the intermediate housing part, respectively, the first housing part comprises a first water storage cavity therein, the second housing part comprises a second water storage cavity therein, the intermediate housing part comprises an intermediate water storage cavity therein, and the first water storage cavity, the second water storage cavity and the intermediate water storage cavity are communicated to form the water storage cavity.

14. The cleaning water tank according to claim 13, wherein one of the first housing part and the second housing part comprises the water injection port, and the other one of the first housing part and the second housing part comprises the switch assembly.

15. The cleaning water tank according to claim 1, wherein a top of the water tank housing comprises another water injection port.

16. The cleaning water tank according to claim 1, wherein the water tank housing comprises a first vent, and the first vent is communicated with the inside of the water storage cavity and the outside of the water storage cavity; and
the switch assembly is configured to block the first vent to isolate the water storage cavity from the outside air, in case that the switch assembly is in the closed position, and the switch assembly is configured to expose the first vent to allow the water storage cavity to be communicated with the outside air to form the pressure difference, in case that the switch assembly is in the open position.

17. A cleaning device, comprising:
a cleaning brush; and
a cleaning water tank comprising:
a water tank housing comprising a water storage cavity therein, a water injection port in a side of the water tank housing, and a water outlet in a bottom of the water tank housing, and the water injection port and the water outlet being both communicated with the water storage cavity; and
a switch assembly movably arranged to the water tank housing, wherein the water storage cavity is configured to be isolated from an outside air, in case that the switch assembly is in a closed position, and the water storage cavity is configured to be communicated with the outside air to form a pressure difference, in case that the switch assembly is in an open position, to allow water in the water storage cavity to be discharged from the water tank housing via the water outlet under the action of the pressure difference,
wherein the cleaning brush is detachably connected with the water tank housing of the cleaning water tank.
